(19) United States
(12) Patent Application Publication
(10) Pub. No.: US 2017/0080701 A1
(43) Pub. Date: Mar. 23, 2017

(54) UPPER PLATFORM WITH A COOLING DEVICE, AND A WORKING METHOD THEREOF

(71) Applicant: Tian-Sheng LIU, Taipei City (TW)

(72) Inventor: Tian-Sheng LIU, Taipei City (TW)

(21) Appl. No.: 14/861,057

(22) Filed: Sep. 22, 2015

(51) Int. Cl. B41F 23/04

(52) U.S. Cl. CPC B41F 23/0476

(57) ABSTRACT

An upper platform with a cooling device includes an upper platform, a heat insulation layer and a heating layer. A cooling layer having a cooling medium is disposed between the upper platform and the heat insulation layer. A working method of the upper platform with the cooling device includes that the coolant continuously flows into the cooling medium inlet, circulates in the pathway of the cooling layer, and then flows out of the cooling medium outlet. The advantages of the present invention include (1) the heat transmission from the heating layer to the upper platform is further reduced, which decreases the heat deformation of the upper platform and the relevant parts thereof, ensures the stability of equipment, and improves the precision of hot stamping and other processes of the equipment; and (2) the present invention is simple in structure, easy to be realized and convenient in operation.

### BACKGROUND OF THE INVENTION

a) Field of the Invention

The invention applies to a printing machine, and more particularly to an upper platform with a heating part on post-press equipment, namely the upper platform with a cooling device, and a working method thereof.

b) Description of the Prior Art

The post-press equipment usually needs to be heated up in partial processing, especially during hot stamping (the so-called hot stamping refers to a technical process that an electrified aluminium foil is hot stamped on a surface of printing stock under certain temperature and pressure). Although a heat insulation layer is disposed between a heating plate and an upper platform (working platform) which are widely used on hot stamping equipment, part of heat can still be transmitted to the upper platform, and then transmitted to large wallboards connected to both sides of the upper platform and other parts, causing heat deformation to relevant parts due to high heat. The heat deformation will in turn affect the precision of hot stamping or embossing work of equipment. Therefore, how to prevent heat transmission and ensure the processing precision is an issue for the post-press equipment, and also a problem that must be solved urgently.

Since the existing mechanism mentioned above has many disadvantages, it is necessary to invent a device with a simple structure and easy realization, which can solve the problem that the hot stamping precision of the equipment is reduced due to the temperature rise in processing.

### SUMMARY OF THE INVENTION

The present invention aims to design an upper platform with a cooling device and a working method thereof, which can solve the disadvantages of the prior art, wherein a cooling medium is circulated in a pathway of a cooling layer to further prevent the temperature of the heating plate from being transmitted to the upper platform and reduce the deformation of the upper platform and the relevant parts thereof due to the temperature rise, thereby ensuring the processing precision.

The technical means of the present invention is to provide an upper platform with a cooling device, comprising the upper platform, a heat insulation layer and a heating layer. The present invention is characterized in that a cooling layer is disposed between the upper platform and the heat insulation layer, and an interior of the said cooling layer is provided with the cooling medium.

The said cooling layer is integrated with the upper platform as a whole, namely a pathway is formed in the upper platform, and the cooling medium circulates in the pathway.

The cooling layer is independently installed between the upper platform and the heat insulation layer; an interior of the cooling layer is provided with a pathway, and the cooling medium circulates in the pathway.

A side of the said cooling layer is provided with a cooling medium inlet and a cooling medium outlet.

The said cooling medium is liquid.

The said heat insulation layer is screwed with the heating layer. An upper surface of the heating layer fits with a lower surface of the heat insulation layer, and a lower surface of the heating layer fits with an upper surface of a honeycomb plate.

The said upper platform with a cooling device is installed on a host part of a printing machine and corresponds to a lower platform of the host part. The said printing machine also includes a sheet transferring unit, an aluminum foil, a chain, a hot stamping part, a gripper bar and a sheet delivery unit. An output end of the sheet transferring unit is connected to the host part; the aluminum foil passes through between the upper platform and the lower platform; the gripper bar is connected to the chain; the host part is installed in front of the hot stamping part; a rear part of the hot stamping part is connected to the sheet delivery unit; and the chain forms a closed loop by passing through the host part, the hot stamping part and the sheet delivery unit.

A working method of the abovementioned upper platform with a cooling device comprises the following steps:

a) The coolant continuously flows into the cooling medium inlet, circulates in the pathway of the cooling layer, and then flows out of the cooling medium outlet;
b) The heating layer starts to heat up, the temperature is transmitted to the heat insulation layer which absorbs part of heat, and the residual is heat is continuously transmitted;
c) The heat is transmitted to the lower part of the cooling layer, and then dissipated through the continuous circulation of the coolant to prevent the temperature from being transmitted to the upper platform;
d) The heating layer continues heating up, and the heat is transmitted to the honeycomb plate to make the temperature thereof reach the working temperature.

The working method of the upper platform with a cooling device also comprises the following steps that a sheet is fed to the host part through the sheet transferring unit, and then clamped by the gripper bar on the chain; the aluminum foil is hot stamped on the sheet which is delivered from the host part to the hot stamping part between the upper platform and the lower platform of the host part; the sheet is clamped by the gripper bar and delivered to the sheet delivery unit through the hot stamping part to accomplish delivering the sheet.

The present invention is provided with the following advantages. First of all, the heat transmission from the heating layer to the upper platform is further reduced, which decreases the heat deformation of the upper platform and the relevant parts thereof, ensure the stability of the equipment and improve the precision of the hot stamping and other processes of the equipment. Secondly, the present invention is simple in structure, easy to be realized and convenient in operation.

### BRIEF DESCRIPTION OF THE DRAWINGS

FIG. 1 shows a structure schematic view of an upper platform with a cooling device, according to the present invention.

FIG. 2 shows a schematic view of an embodiment of the upper platform with the cooling device, according to the present invention.

### DETAILED DESCRIPTION OF THE PREFERRED EMBODIMENTS

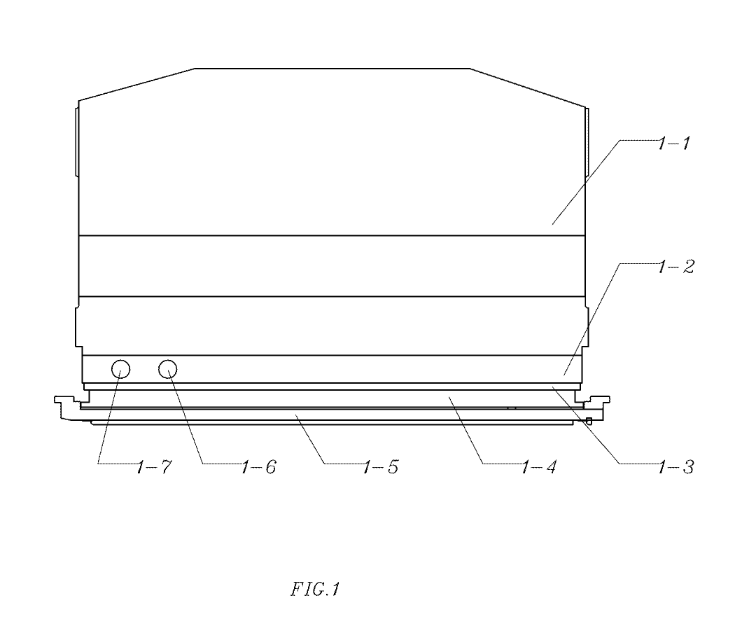

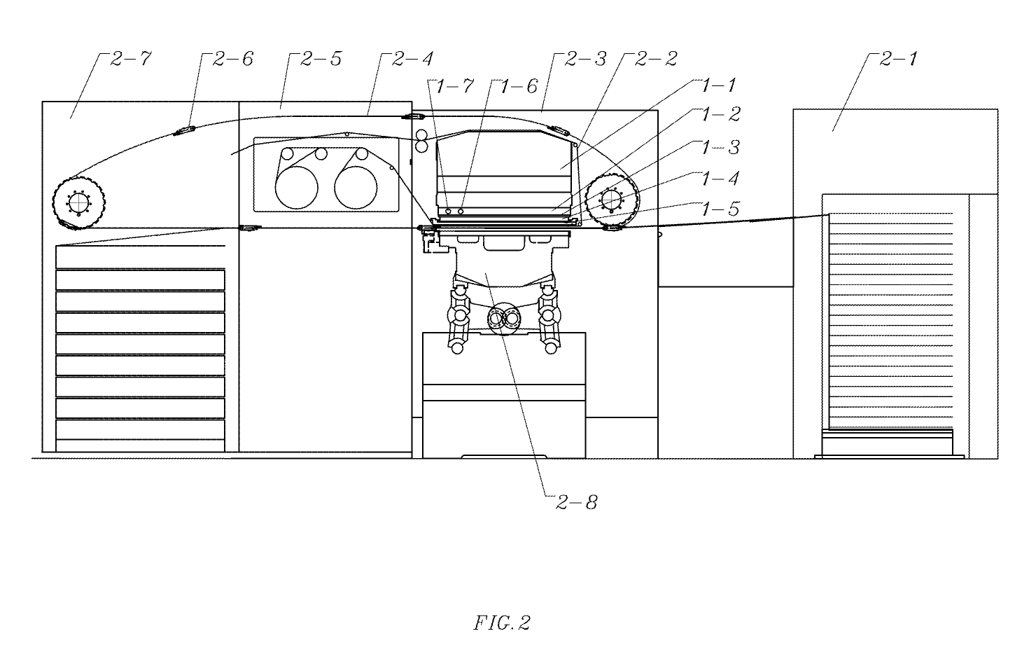

The present invention discloses an upper platform with a cooling device (as shown in FIG. 1 and FIG. 2), comprising an upper platform 1-1, a heat insulation layer 1-3 and a heating layer 1-4, wherein a cooling layer 1-2 is disposed between the upper platform 1-1 and the heat insulation layer 1-3 and an interior of the cooling layer 1-2 is provided with a cooling medium.

The said cooling layer 1-2 is independently installed between the upper platform 1-1 and the heat insulation layer 1-3; an interior of the cooling layer 1-2 is provided with a pathway and the cooling medium circulates in the pathway (as shown in FIG. 1 and FIG. 2).

A side of the said cooling layer 1-2 is provided with a cooling medium inlet 1-6 and a cooling medium outlet 1-7(as shown in FIG. 1 and FIG. 2).

The said cooling medium is liquid.

The said heat insulation layer 1-3 is screwed with the heating layer 1-4. An upper surface of the heating layer 1-4 fits with a lower surface of the heat insulation layer 1-3, and a lower surface of the heating layer 1-4 fits with an upper surface of a honeycomb plate 1-5 (as shown in FIG. 1 and FIG. 2).

The said upper platform with a cooling device is installed on a host part 2-3 of a printing machine and corresponds to a lower platform 2-8 installed on the host part 2-3. The printing machine also comprises a sheet transferring unit 2-1, an aluminum foil 2-2, a chain 2-4, a hot stamping part 2-5, a gripper bar 2-6 and a sheet delivery unit 2-7, wherein an output end of the sheet transferring unit 2-1 is connected to the host part 2-3; the aluminum foil 2-2 passes through between the upper platform 1-1 and the lower platform 2-8; the gripper bar 2-6 is connected to the chain 2-4; the host part 2-3 is installed in front of the hot stamping part 2-5, a rear part of the hot stamping part 2-5 is connected to the sheet delivery unit 2-7; and the chain 2-4 forms a closed loop by passing through the host part 2-3, the hot stamping part 2-5 and the sheet delivery unit 2-7 (as shown in FIG. 2).

A working method of the upper platform with a cooling device (as shown in FIG. 1 and FIG. 2) comprises the following steps:

a) The coolant continuously flows into the cooling medium inlet 1-6, circulates in the pathway of the cooling layer 1-2, and then flows out of the cooling medium outlet 1-7;
b) The heating layer 1-4 starts to heat up, the temperature is transmitted to the heat insulation layer 1-3 which absorbs part of heat, and the residual heat is continuously transmitted;
c) The heat is transmitted to the lower part of the cooling layer 1-2, and then dissipated through the continuous circulation of the coolant so as to prevent the temperature from being transmitted to the upper platform 1-1; and
d) The heating layer 1-4 continues heating up, and the heat is transmitted to the honeycomb plate 1-5 to make the temperature thereof reach the working temperature.

The working method of the upper platform with a cooling device also comprises the following steps that a) a sheet is fed to the host part 2-3 through the sheet transferring unit 2-1, and then clamped by the gripper bar 2-6 on the chain 2-4; b) the aluminum foil is hot stamped onto the sheet which is delivered from the host part 2-3 to the hot stamping part 2-5 between the upper platform 1-1 and the lower platform 2-8 of the host part 2-3; c) the sheet is clamped by the gripper bar 2-6 and delivered to the sheet delivery unit 2-7 through the hot stamping part 2-5 to accomplish delivering the sheet.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An upper platform with a cooling device, comprising an upper platform, a heat insulation layer and a heating layer, wherein a cooling layer is disposed between the upper platform and the heat insulation layer and an interior of the cooling layer is provided with a cooling medium.

2. The upper platform with a cooling device, according to claim 1, wherein the cooling layer is integrated with the upper platform as a whole, a pathway is formed in the upper platform, and the cooling medium circulates in the pathway.

3. The upper platform with a cooling device, according to claim 1, wherein the cooling layer is independently installed between the upper platform and the heat insulation layer, the interior of the cooling layer is provided with a pathway, and the cooling medium circulates in the pathway.

4. The upper platform with a cooling device, according to claim 1, wherein a side of the cooling layer is provided with a cooling medium inlet and a cooling medium outlet.

5. The upper platform with a cooling device, according to claim 2, wherein a side of the cooling layer is provided with a cooling medium inlet and a cooling medium outlet.

6. The upper platform with a cooling device, according to claim 3, wherein a side of the cooling layer is provided with a cooling medium inlet and a cooling medium outlet.

7. The upper platform with a cooling device, according to claim 1, wherein the cooling medium is liquid.

8. The upper platform with a cooling device, according to claim 2, wherein the cooling medium is liquid.

9. The upper platform with a cooling device, according to claim 3, wherein the cooling medium is liquid.

10. The upper platform with a cooling device, according to claim 1, wherein the heat insulation layer is screwed with the heating layer, an upper surface of the heating layer fits with a lower surface of the heat insulation layer, and a lower surface of the heating layer fits with an upper surface of a honeycomb plate.

11. The upper platform with a cooling device, according to claim 1, wherein the upper platform with a cooling device is installed on a host part of a printing machine and corresponds to a lower platform of the host part; the printing machine comprises a sheet transferring unit, an aluminum foil, a chain, a hot stamping part, a gripper bar and a sheet delivery unit; an output end of the sheet transferring unit being connected to the host part; the aluminum foil passing through between the upper platform and the lower platform; the gripper bar being connected to the chain; the host part being installed in front of the hot stamping part, a rear part of the hot stamping part being connected to the sheet delivery unit; and the chain forming a closed loop by passing through the host part, the hot stamping part and the sheet delivery unit.

12. A working method of the upper platform with a cooling device, comprising the steps of:
a) making coolant continuously flowing into a cooling medium inlet, circulating in a pathway of the cooling layer, and then flowing out of the cooling medium outlet;
b) heating up the heating layer, temperature being transmitted to the heat insulation layer thereby absorbing part of heat, and residual heat being continuously transmitted;
c) transmitting the heat to a lower part of the cooling layer, and then dissipating through the continuous circulation of the coolant, thereby preventing the temperature from being transmitted to an upper platform; and
d) heating up the heating layer continuously, and the heat being transmitted to a honeycomb plate to make the temperature thereof reach the working temperature.

13. A working method of the upper platform with a cooling device, wherein the working method further comprising the steps of:
a) having a sheet fed to a host part through a sheet transferring unit, and then clamped by a gripper bar on a chain;
b) making an aluminum foil to be hot stamped onto the sheet which is delivered from the host part to a hot stamping part between an upper platform and a lower platform of the host part;
c) having the sheet clamped by the gripper bar and delivered to the sheet delivery unit through the hot stamping part to accomplish delivering the sheet.
